(19) United States
(12) Patent Application Publication
(10) Pub. No.: US 2022/0032942 A1
(43) Pub. Date: Feb. 3, 2022

(54) INFORMATION PROVIDING DEVICE AND INFORMATION PROVIDING METHOD

(71) Applicant: Mitsubishi Electric Corporation, Tokyo (JP)

(72) Inventor: Takumi TAKEI, Tokyo (JP)

(73) Assignee: Mitsubishi Electric Corporation, Tokyo (JP)

(21) Appl. No.: 17/278,732

(22) PCT Filed: Oct. 16, 2018
(86) PCT No.: PCT/JP2018/038502

§ 371 Date: Mar. 23, 2021

(51) Int. Cl. B60W 50/14; B60W 40/09; G06K 9/00

(52) U.S. Cl. CPC B60W 50/14; B60W 40/09; G06K 9/00845; B60W 2554/00; B60W 2040/089; B60W 2540/21; B60W 2540/221; B60W 2556/10; B60W 2540/229; B60W 2540/225

(57) ABSTRACT

A confusion degree determining unit determines a degree of confusion of an occupant by using occupant state information acquired by an occupant state acquiring unit. A recognition degree determining unit determines a degree of recognition of the occupant, with respect to surrounding conditions and automatic control of a vehicle, by using surrounding condition information and control information acquired by a host vehicle status acquiring unit and the occupant state information acquired by the occupant state acquiring unit. An information generation unit generates information to be provided to the occupant by using the surrounding condition information and control information acquired by the host vehicle status acquiring unit, the degree of confusion determined by the confusion degree determining unit, and the degree of recognition determined by the recognition degree determining unit.

### TECHNICAL FIELD

The present invention relates to an information providing device and an information providing method for providing an occupant with information regarding control of a vehicle.

### BACKGROUND ART

An information providing device has conventionally been known which allows an occupant to easily grasp a cause of occurrence of a sudden movement when a sudden movement of a host vehicle occurs due to automatic control of the vehicle.

For example, a display device for a vehicle described in Patent Literature 1 determines whether or not the automatic control of the host vehicle is to be executed depending on surrounding conditions of the host vehicle, and, when it is determined that the automatic control is to be executed, generates an image indicating the surrounding conditions including the cause of occurrence of the automatic control on the basis of the surrounding conditions, and displays the generated image on an image display means provided in the host vehicle.

### CITATION LIST

### Patent Literature

Patent Literature 1: JP 2017-187839 A

### SUMMARY OF INVENTION

### Technical Problem

A conventional information providing device such as the display device for a vehicle described in Patent Literature 1 has displayed an image on the basis of only a case where a sudden movement of the host vehicle occurs. For that reason, images are displayed for an unnecessary scene and unnecessary content, such as a case where the occupant can predict the sudden movement in advance and a case where the occupant can recognize the cause of occurrence of the sudden movement, thereby causing annoyance to the occupant. Furthermore, since the image is not displayed when a movement occurs other than a sudden movement, the occupant who cannot recognize the cause of occurrence of the movement feels anxious. As described above, there has been a problem in which the conventional information providing device cannot provide information with no excess or deficiency.

The present invention has been made to solve the above problem, and an object thereof is to provide information with no excess or deficiency.

### Solution to Problem

An information providing device according to the present invention includes: a host vehicle status acquiring unit for acquiring first information indicating surrounding conditions of a vehicle and second information regarding automatic control of the vehicle; an occupant state acquiring unit for acquiring third information indicating a state of an occupant of the vehicle; a confusion degree determining unit for determining a degree of confusion of the occupant by using the third information acquired by the occupant state acquiring unit; a recognition degree determining unit for determining a degree of recognition of the occupant, with respect to the surrounding conditions and the automatic control of the vehicle, by using the first information, the second information, and the third information acquired by the host vehicle status acquiring unit and the occupant state acquiring unit; and an information generation unit for generating information to be provided to the occupant by using the first information and the second information acquired by the host vehicle status acquiring unit, the degree of confusion determined by the confusion degree determining unit, and the degree of recognition determined by the recognition degree determining unit.

### Advantageous Effects of Invention

According to the present invention, the information to be provided to the occupant is generated on the basis of the information indicating the state of the occupant of the vehicle in addition to the information indicating the surrounding conditions of the vehicle and the information regarding the automatic control of the vehicle, so that information can be provided with no excess or deficiency.

### BRIEF DESCRIPTION OF DRAWINGS

FIG. 1 is a block diagram illustrating a configuration example of an information providing device according to a first embodiment.

FIG. 2 is a diagram illustrating an example of an information generation table included in the information providing device according to the first embodiment.

FIG. 3 is a flowchart illustrating an operation example of the information providing device according to the first embodiment.

FIGS. 4A, 4B, and 4C are diagrams illustrating information providing examples of the information providing device 1 according to the first embodiment.

FIG. 5 is a diagram illustrating a hardware configuration example of the information providing device according to the first embodiment.

### DESCRIPTION OF EMBODIMENTS

Hereinafter, to explain the present invention in more detail, modes for carrying out the present invention will be described by referring to the accompanying drawings.

### First Embodiment

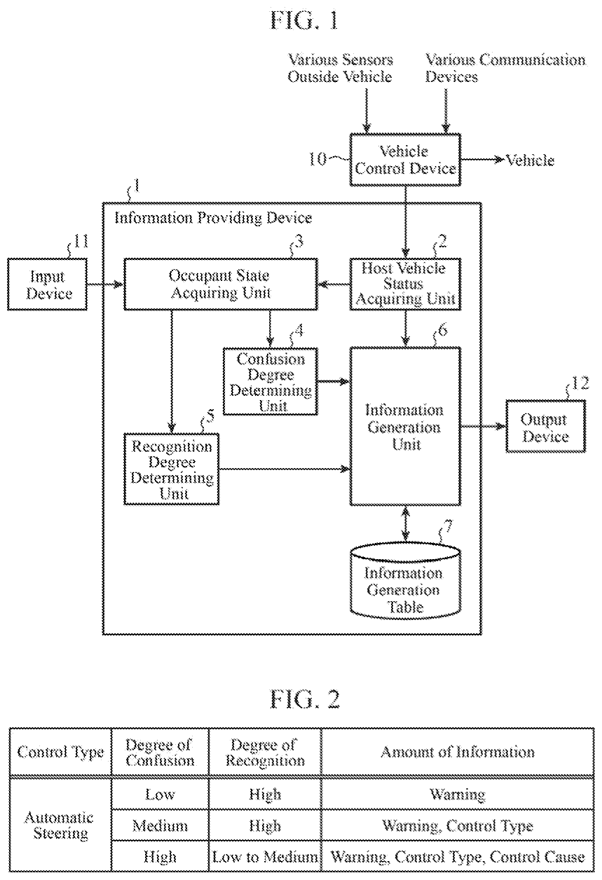

FIG. 1 is a block diagram illustrating a configuration example of an information providing device 1 according to a first embodiment. The information providing device 1 is mounted on a vehicle. Furthermore, the information providing device 1 is connected to a vehicle control device 10, an input device 11, and an output device 12 mounted on the same vehicle.

The vehicle control device 10 is connected to various sensors outside the vehicle, such as a millimeter wave radar, a Light Detection And Ranging (LIDAR), and a corner sensor, and various communication devices such as a Vehicle to Everything (V2X) communication device and a Global Navigation Satellite System (GNSS) receiver, and implements automatic control (including driving assistance) of the vehicle while monitoring surrounding conditions. Furthermore, the vehicle control device 10 may implement the automatic control (including driving assistance) of the vehicle while transmitting and receiving information to and from a roadside device equipped with an optical beacon, or an external device mounted on another vehicle or the like.

The vehicle control device 10 outputs information indicating the type of the automatic control of the vehicle (hereinafter referred to as “control information”), such as acceleration, braking, and steering. Note that, the control information may include not only information relating to control currently in operation, but also information relating to control scheduled to be operated in the future. Furthermore, the vehicle control device 10 outputs information indicating surrounding conditions of the vehicle (hereinafter referred to as “surrounding condition information”), the surrounding conditions being a cause of activation of automatic control of the vehicle.

The input device 11 includes a microphone, a remote controller, a touch sensor, or the like for receiving an input by an occupant riding in the vehicle, and a camera, an infrared sensor, a biological sensor, or the like for monitoring a state of the occupant. The input device 11 outputs information indicating the state of the occupant (hereinafter, occupant state information) detected by using the microphone, remote controller, touch sensor, camera, infrared sensor, biological sensor, or the like. The occupant state information includes at least one of an occupant's facial expression, line of sight, behavior, voice, heart rate, brain wave, or sweat rate. Furthermore, the input device 11 may recognize an individual by using an occupant's face image, voice, or the like, thereby generate information indicating an experience value for each occupant with respect to the automatic control of the vehicle, such as the number of rides and ride time, and include the information in the occupant state information. Note that, the occupant state information is not limited to the above example, and may be any information indicating the state of the occupant.

The output device 12 is an audio output device such as a speaker, a display device using liquid crystal or organic electro luminescence (EL), or a steering wheel, a seat, or the like having a built-in actuator and thereby capable of vibrating.

The information providing device 1 includes a host vehicle status acquiring unit 2, an occupant state acquiring unit 3, a confusion degree determining unit 4, a recognition degree determining unit 5, an information generation unit 6, and an information generation table 7. A target to which the information providing device 1 provides information is not only a driver, but all of a plurality of the occupants can also be targets; however, here, for the sake of simplification of description, the description will be given assuming that there is one occupant.

The host vehicle status acquiring unit 2 acquires the control information indicating the control type of the host vehicle and the surrounding condition information that is a control cause from the vehicle control device 10, and outputs these pieces of the information to the occupant state acquiring unit 3 and the information generation unit 6.

The occupant state acquiring unit 3 acquires the occupant state information from the input device 11 and also acquires the control information and the surrounding condition information from the host vehicle status acquiring unit 2, and outputs the acquired information to the recognition degree determining unit 5 or the confusion degree determining unit 4. Specifically, the occupant state acquiring unit 3 acquires the control information from the host vehicle status acquiring unit 2 and detects whether or not the automatic control of the vehicle is activated on the basis of the control information. Then, when detecting that the automatic control of the vehicle is activated, the occupant state acquiring unit 3 outputs time-series data of the occupant state information within a certain period of time (for example, 1 minute) including the time of activation and the time before and after the time of activation to the confusion degree determining unit 4 and the recognition degree determining unit 5 so that a state change of the occupant within the certain period of time can be seen. Furthermore, when detecting that the automatic control of the vehicle is activated, the occupant state acquiring unit 3 outputs time-series data of the control information and the surrounding condition information within the certain period of time (for example, 1 minute) including the time of activation and the time before and after the time of activation to the recognition degree determining unit 5 so that state changes of the host vehicle and its surrounding conditions within the certain period of time can be seen.

The confusion degree determining unit 4 acquires the occupant state information from the occupant state acquiring unit 3 and determines a degree of confusion of the occupant on the basis of the state of the occupant. For example, on the basis of the volume of a voice instantaneously uttered by the occupant, the confusion degree determining unit 4 determines the degree of confusion in such a manner that the degree of confusion is “low” when the sound pressure is less than 60 dB, the degree of confusion is “medium” when the sound pressure is greater than or equal to 60 dB and less than 70 dB, and the degree of confusion is “high” when the sound pressure is greater than or equal to 70 dB. Note that, the confusion degree determining unit 4 may make determination by using not only the volume of the voice but also prosody information or language information. Furthermore, the confusion degree determining unit 4 may combine a plurality of pieces of information such as a voice, a camera image, and a heart rate to make determination, by using a general method such as a Deep Neural Network (DNN) method. Furthermore, the confusion degree determining unit 4 may make determination individually from at least one of the occupant's facial expression, line of sight, behavior, heart rate, brain wave, or sweat rate that is information other than a voice, by using a general method such as the DNN method. Moreover, when the experience value of the occupant with respect to the automatic control of the vehicle is high, the confusion degree determining unit 4 may decrease the degree of confusion, considering that a degree of understanding of the occupant with respect to the automatic control of the vehicle is high. Furthermore, when a degree of experience of the occupant with respect to the automatic control of the vehicle is low, the confusion degree determining unit 4 may increase the degree of confusion, considering that the degree of understanding of the occupant with respect to the automatic control of the vehicle is low. After that, the confusion degree determining unit 4 outputs the determined degree of confusion to the information generation unit 6.

The recognition degree determining unit 5 acquires the surrounding condition information, the control information, and the occupant state information from the occupant state acquiring unit 3. Then, the recognition degree determining unit 5 determines a degree of recognition of the occupant with respect to the surrounding conditions of the vehicle and the automatic control of the vehicle on the basis of the state of the occupant by using the acquired these pieces of information. For example, the recognition degree determining unit 5 detects a degree of opening of the occupant's eyelid by using a camera image or the like, determines whether or not the occupant is in an awakening state on the basis of the degree of opening of the eyelid, and determines a confirmation status of the occupant for a periphery of the vehicle, or the like, on the basis of the occupant's awakening state, face orientation, line-of-sight direction, and the like. Then, the recognition degree determining unit 5 determines the degree of recognition in such a manner that the degree of recognition is “low” when the occupant is in a non-awakening state such as during sleeping, the degree of recognition is “medium” when the occupant is in the awakening state but is in a state in which conditions outside the vehicle cannot be visually recognized such as during operation of a smartphone or the like, and the degree of recognition is “high” when the occupant is in a state in which the conditions outside the vehicle can be visually recognized. Note that, similarly to the confusion degree determining unit 4, the recognition degree determining unit 5 may combine a plurality of pieces of information to make determination, by using a general method such as the DNN method. After that, the recognition degree determining unit 5 outputs the determined degree of recognition to the information generation unit 6.

The information generation unit 6 acquires the surrounding condition information and the control information from the host vehicle status acquiring unit 2, acquires the degree of confusion from the confusion degree determining unit 4, and acquires the degree of recognition from the recognition degree determining unit 5. Then, the information generation unit 6 generates information to be provided to the occupant on the basis of the surrounding condition information, the control information, the degree of confusion, and the degree of recognition, by referring to the information generation table 7. An information generation method by the information generation unit 6 will be described later.

The information generation table 7 is, for example, a table that defines an amount of information of the information to be provided to the occupant depending on the degree of confusion and the degree of recognition, with respect to the control type. FIG. 2 is a diagram illustrating an example of the information generation table 7 included in the information providing device 1 according to the first embodiment. In the example of FIG. 2, the amount of information to be provided is increased as the degree of confusion of the occupant is higher with respect to the control type “automatic steering”. Furthermore, the amount of information to be provided is increased as the degree of recognition of the occupant is lower with respect to the control type “automatic steering”. Note that, types of the amount of information with respect to combinations of high-low of the degree of confusion and high-low of the degree of recognition are not limited to the example of FIG. 2. For example, a total of nine types of the amount of information may be defined by the information generation table 7, which are three types of the amount of information of the degree of recognition “low”, “medium”, and “high” with respect to the degree of confusion “low”, three types of the amount of information of the degree of recognition “low”, “medium”, and “high” with respect to the degree of confusion “medium”, and three types of the amount of information of the degree of recognition “low”, “medium”, and “high” with respect to the degree of confusion “high”. Furthermore, in the example of FIG. 2, the degree of confusion and the degree of recognition are expressed in three levels of “low”, “medium”, and “high”, but it is not limited to the three levels. The degree of confusion and the degree of recognition may be expressed by a numerical value from “1” to “100”, for example, and in this case, finer control is possible of the information to be provided to the occupant.

Furthermore, in FIG. 2, as the amount of information of the information to be provided to the occupant, three types are exemplified of a warning alone, the warning and a control type, and the warning, the control type, and a control cause, but the amount of information is not limited to the three types. Information provision of the warning, the control type, and the control cause is performed by sound, voice, display, or the like. FIG. 2 exemplifies a case where the control type is “automatic steering”, but the control type is not limited to the automatic steering, and may be “automatic braking”, “intersection right or left turn”, or the like. Furthermore, in FIG. 2, it is set so that the information is provided to the occupant regardless of the values of the degree of confusion and the degree of recognition, but it may be set so that the information is not provided when the degree of confusion is “low” and the degree of recognition is “high”, for example. As described above, the information generation unit 6 may be configured to provide information when the degree of confusion is greater than or equal to a predetermined value, and the degree of recognition is less than a predetermined value, and not to provide information when the degree of confusion is less than the predetermined value, and the degree of recognition is greater than or equal to the predetermined value.

Next, the operation will be described of the information providing device 1 according to the first embodiment.

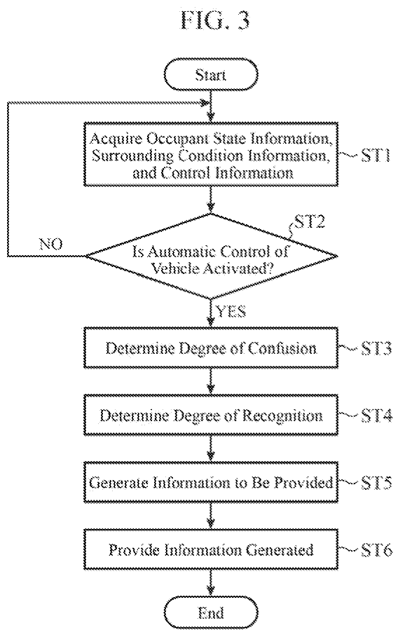

FIG. 3 is a flowchart illustrating an operation example of the information providing device 1 according to the first embodiment. The information providing device 1 repeats the operation illustrated in the flowchart of FIG. 3 while the engine of the vehicle is in operation, for example.

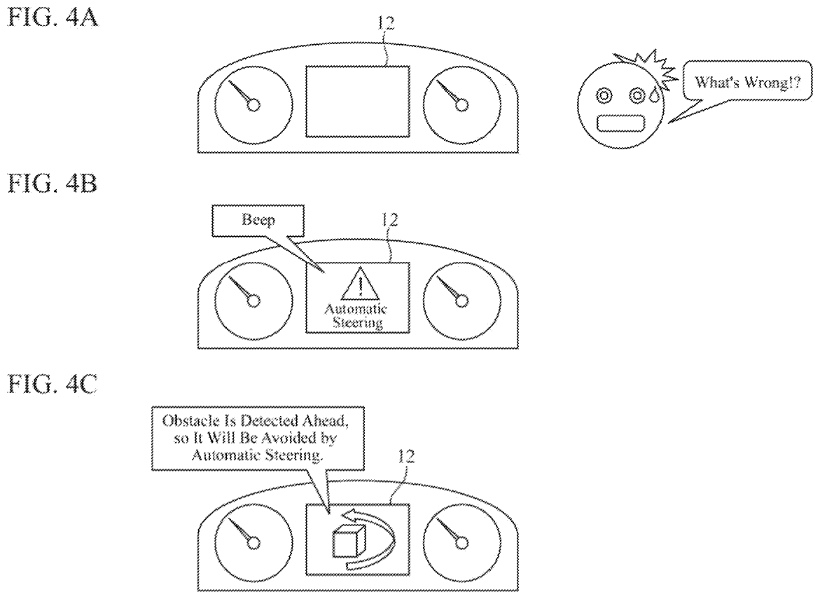

FIGS. 4A, 4B, and 4C are diagrams illustrating information providing examples of the information providing device 1 according to the first embodiment. Here, as illustrated in FIG. 4A, a case will be described as an example where a display device that is a type of the output device 12, is installed in the instrument panel of the vehicle. Furthermore, it is assumed that a speaker (not illustrated) that is a type of the output device 12 is also installed in the instrument panel.

Furthermore, hereinafter, a case is assumed where the vehicle control device 10 detects an obstacle in front of the vehicle and activates automatic steering to avoid the obstacle. In this case, the vehicle control device 10 outputs, to the host vehicle status acquiring unit 2, the control information in which the control type is “automatic steering” and the surrounding condition information in which the control cause is “an obstacle ahead is detected”.

In step ST1, the host vehicle status acquiring unit 2 acquires the above-mentioned surrounding condition information and control information from the vehicle control device 10, and the occupant state acquiring unit 3 acquires the occupant state information from the input device 11.

In step ST2, the occupant state acquiring unit 3 detects whether or not the automatic control of the vehicle is activated on the basis of the control information acquired by the host vehicle status acquiring unit 2. When detecting that the automatic control of the vehicle is activated (step ST2 “YES”), the occupant state acquiring unit 3 outputs the occupant state information within a certain period of time including the time of activation and the time before and after the time of activation to the confusion degree determining unit 4 and the recognition degree determining unit 5, and otherwise (step ST2 “NO”), the process returns to step ST1.

In step ST3, the confusion degree determining unit 4 determines the degree of confusion of the occupant within the certain period of time including the time of activation and the time before and after the time of activation on the basis of the occupant state information acquired from the occupant state acquiring unit 3. For example, as illustrated in FIG. 4A, when the volume of a surprised voice such as “What's wrong!?” of the occupant is 70 dB, the confusion degree determining unit 4 determines that the degree of confusion is “high”.

In step ST4, the recognition degree determining unit 5 determines the degree of recognition of the occupant with respect to the surrounding conditions of the vehicle and the automatic control of the vehicle, within the certain period of time including the time of activation and the time before and after the time of activation, on the basis of the surrounding condition information, the control information, and the occupant state information acquired from the occupant state acquiring unit 3. For example, when the occupant is in the awakening state and thereby can grasp the control state of the host vehicle to some extent but does not direct the line of sight out of the window and thereby cannot fully recognize the conditions outside the vehicle, the recognition degree determining unit 5 determines that the degree of recognition is “medium”.

In step ST5, the information generation unit 6 generates information depending on the type of the automatic control of the vehicle, the degree of confusion determined in step ST3, and the degree of recognition determined in step ST4, by referring to the information generation table 7. For example, when the control type is “automatic steering”, the degree of confusion is “high”, and the degree of recognition is “medium”, the information generation unit 6 determines that the amount of information to be provided to the occupant corresponds to the warning, the control type, and the control cause on the basis of the information generation table 7 as illustrated in FIG. 2. Then, the information generation unit 6 generates a warning sound such as “beep” or a warning screen for informing the occupant that the automatic control is activated. Furthermore, the information generation unit 6 generates at least one of a voice or a display screen for informing the occupant of “automatic steering” that is the control type. Moreover, the information generation unit 6 generates at least one of a voice or a display screen for informing the occupant of “an obstacle ahead is detected” that is a control cause.

In step ST6, the information generation unit 6 outputs the information generated in step ST5 to the output device 12. When the degree of confusion is “high” and the degree of recognition is “low”, the output device 12 provides the occupant with the information on the warning, the control type, and the control cause generated by the information generation unit 6. For example, first, the information generation unit 6 causes the speaker that is a type of the output device 12 to output a warning sound “beep” as illustrated in FIG. 4B. At the same time, the information generation unit 6 causes the display device that is a type of the output device 12 to display a warning screen including a warning icon and the text “automatic steering”. Subsequently, as illustrated in FIG. 4C, the information generation unit 6 causes the speaker that is a type of the output device 12 to output a voice saying “an obstacle is detected ahead, so it will be avoided by automatic steering” representing “automatic steering” that is the control type and “an obstacle ahead is detected” that is the control cause. At the same time, the information generation unit 6 causes the display device that is a type of the output device 12 to display a screen showing “automatic steering” that is the control type, and “an obstacle ahead is detected” that is the control cause.

Note that, for example, when the degree of confusion is “low” and the degree of recognition is “high”, it is conceivable that the occupant understands why the automatic steering is activated. For that reason, to inform the occupant that the automatic steering is activated, the information generation unit 6 only needs to generate only information such as a warning sound or warning display as illustrated in FIG. 4B.

Furthermore, in FIGS. 4A, 4B and 4C, the information providing device 1 warns the occupant by using the speaker and the display device, but may warn the occupant by vibrating the actuator built in the steering wheel or the seat.

Finally, a hardware configuration of the information providing device 1 will be described.

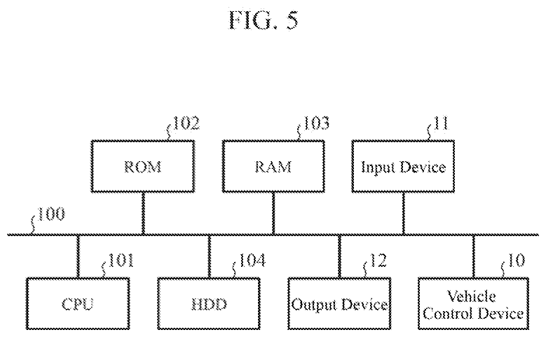

FIG. 5 is a diagram illustrating a hardware configuration example of the information providing device 1 according to the first embodiment. A Central Processing Unit (CPU) 101, a Read Only Memory (ROM) 102, a Random Access Memory (RAM) 103, a Hard Disk Drive (HDD) 104, the vehicle control device 10, the input device 11, and the output device 12 are connected to a bus 100. Functions of the host vehicle status acquiring unit 2, the occupant state acquiring unit 3, the confusion degree determining unit 4, the recognition degree determining unit 5, and the information generation unit 6 in the information providing device 1 are implemented by the CPU 101 that executes a program stored in the ROM 102 or the HDD 104. The CPU 101 may be capable of executing a plurality of processes in parallel by a multi-core or the like. The RAM 103 is a memory used by the CPU 101 during execution of the program. The HDD 104 is an example of an external storage device and stores the information generation table 7. Note that, the external storage device may be other than the HDD 104, and may be a disk such as a Compact Disc (CD) or a Digital Versatile Disc (DVD), or a storage or the like in which a flash memory is adopted such as a Universal Serial Bus (USB) memory or an SD card.

The functions of the host vehicle status acquiring unit 2, the occupant state acquiring unit 3, the confusion degree determining unit 4, the recognition degree determining unit 5, and the information generation unit 6 are implemented by software, firmware, or a combination of software and firmware. The software or firmware is described as a program and stored in the ROM 102 or the HDD 104. The CPU 101 reads and executes the program stored in the ROM 102 or the HDD 104, thereby implementing the functions of the units. That is to say, the information providing device 1 includes the ROM 102 or the HDD 104 for storing the program by which the steps illustrated in the flowchart of FIG. 3 are resultantly executed when the program is executed by the CPU 101. Furthermore, it can also be said that the program causes a computer to execute procedures or methods of the host vehicle status acquiring unit 2, the occupant state acquiring unit 3, the confusion degree determining unit 4, the recognition degree determining unit 5, and the information generation unit 6.

As described above, the information providing device 1 according to the first embodiment includes the host vehicle status acquiring unit 2, the occupant state acquiring unit 3, the confusion degree determining unit 4, the recognition degree determining unit 5, and the information generation unit 6. The host vehicle status acquiring unit 2 acquires information indicating the surrounding conditions of the vehicle and information regarding the automatic control of the vehicle. The occupant state acquiring unit 3 acquires information indicating the state of the occupant of the vehicle. The confusion degree determining unit 4 determines the degree of confusion of the occupant by using the information acquired by the occupant state acquiring unit 3. The recognition degree determining unit 5 determines the degree of recognition of the occupant with respect to the surrounding conditions and automatic control of the vehicle by using pieces of the information acquired by the host vehicle status acquiring unit 2 and the occupant state acquiring unit 3. The information generation unit 6 generates the information to be provided to the occupant by using pieces of the information acquired by the host vehicle status acquiring unit 2, the degree of confusion determined by the confusion degree determining unit 4, and the degree of recognition determined by the recognition degree determining unit 5. With this configuration, the information providing device 1 can change the information to be provided, on the basis of the degree of confusion of the occupant due to the automatic control of the vehicle, and the degree of recognition of the occupant with respect to the surrounding conditions and automatic control of the vehicle, before and after the automatic control. For that reason, for an occupant who does not know very well the control of the automatic driving or the driving assistance by the vehicle control device 10 and thereby feels anxiety, sufficient information can be provided, and thereby a sense of security can be given. Furthermore, for an occupant who understands the control of the automatic driving or the driving assistance by the vehicle control device 10, unnecessary information provision can be reduced, and thereby annoyance can be suppressed. Thus, the information providing device 1 can provide information with no excess or deficiency.

Furthermore, the information generation unit 6 of the first embodiment increases the amount of information to be provided to the occupant as the degree of confusion determined by the confusion degree determining unit 4 is higher, or as the degree of recognition determined by the recognition degree determining unit 5 is lower. As a result, the information providing device 1 can increase or decrease the amount of information to be provided depending on the degree of understanding of the occupant with respect to the control of the automatic driving or the driving assistance by the vehicle control device 10, and thus can provide information with no excess or deficiency.

Note that, in the above, the confusion degree determining unit 4 determines the degree of confusion of the occupant on the basis of the occupant state information within the certain period of time including the time of activation and the time before and after the time of activation of the automatic control of the vehicle, but may estimate a current degree of confusion at the time of activation of the automatic control by using a history of past determination of a degree of confusion performed for the occupant. For example, when the automatic steering of this time is the third time for the occupant, and the degrees of confusion at the time of activation of the previous two times of automatic steering are both “high”, the confusion degree determining unit 4 estimates that the degree of confusion at the time of activation is “high” regardless of the occupant state of this time. As a result of this, the information providing device 1 can immediately provide information appropriately before the occupant is actually confused, and thus can prevent occurrence itself of confusion of the occupant.

Furthermore, in the above, the information generation unit 6 generates the information to be provided simply depending on high-low of the degree of recognition, but may generate the information to be provided, on the basis of to what extent the occupant specifically recognizes the surrounding conditions and the automatic control. For example, a case is assumed where the vehicle control device 10 detects an obstacle in front of the vehicle and activates automatic steering to avoid the obstacle. In this case, the recognition degree determining unit 5 determines whether or not the occupant directs the line of sight to an area outside the vehicle and visually recognizes the obstacle in front of the vehicle, on the basis of the occupant's line-of-sight information and the like. When it is determined by the recognition degree determining unit 5 that the occupant visually recognizes the obstacle in front of the vehicle, the information generation unit 6 determines that the occupant can recognize “automatic steering” that is the control type and “an obstacle ahead is detected” that is the control cause, and does not generate information about the automatic steering. On the other hand, when it is determined by the recognition degree determining unit 5 that the occupant is not aware of the obstacle in front of the vehicle, the information generation unit 6 determines that the occupant cannot recognize “automatic steering” that is the control type and “an obstacle ahead is detected” that is the control cause, and generates information about the automatic steering. As described above, the recognition degree determining unit 5 determines a matter recognized by the occupant, in the surrounding conditions and automatic control of the vehicle, and the information generation unit 6 generates information regarding the surrounding conditions and automatic control of the vehicle which are other than the matter determined, by the recognition degree determining unit 5, to be recognized by the occupant. Thereby, information can be more appropriately provided with no excess or deficiency.

Note that, the information generation unit 6 generates information to be provided to the occupant by using the surrounding condition information and control information acquired by the host vehicle status acquiring unit 2, the degree of confusion determined by the confusion degree determining unit 4, and the degree of recognition acquired by the recognition degree determining unit 5, and provides the generated information to the occupant, and then, when a degree of confusion newly determined by the confusion degree determining unit 4 does not decrease by greater than or equal to a predetermined value, the information generation unit 6 may increase the amount of information to be provided to the occupant. Here, it is assumed that the predetermined value corresponds to one level of the degree of confusion, for example. The information generation unit 6 determines that the amount of information to be provided corresponds to the warning and control type depending on the degree of confusion “medium” and the degree of recognition “high”, and provides the information by using the output device 12, and then if the degree of confusion does not decrease from “medium” to “low”, the information generation unit 6 provides information again by adding the control cause to the warning and control type even though the degree of confusion is “medium”. By doing so, the information providing device 1 can increase the amount of information in a scene where the amount of the provided information is insufficient, and thereby can more appropriately provide information with no excess or deficiency.

Furthermore, when the degree of confusion of the occupant is increased due to a conversation with another occupant, the information generation unit 6 may set the information to be provided to the occupant to be unchanged from the information before the degree of confusion increases. In this case, when a plurality of occupants alternately speaks, the occupant state acquiring unit 3 determines that the plurality of occupants has a conversation, on the basis of voices from the input device 11. Alternatively, when the plurality of occupants speaks while looking at each other, the occupant state acquiring unit 3 may determine that the plurality of occupants has a conversation, on the basis of the camera image and voices from the input device 11. Moreover, the occupant state acquiring unit 3 determines whether or not the occupants speak about a topic that is not related to the surrounding conditions and automatic control of the vehicle, on the basis of voices of the occupants. Then, when the degree of confusion of an occupant to be provided with information is increased, and when it is determined by the occupant state acquiring unit 3 that the plurality of occupants has a conversation about a topic that is not related to the surrounding conditions and automatic control of the vehicle, the information generation unit 6 determines that the degree of confusion of the occupant to be provided with the information is increased due to the conversation with the other occupant, and does not change the information to be provided to the occupant. On the other hand, when the degree of confusion of the occupant to be provided with information is increased, and when the occupant does not speak or it is determined by the occupant state acquiring unit 3 that the plurality of occupants has a conversation about a topic that is related to the surrounding conditions and automatic control of the vehicle, the information generation unit 6 determines that the degree of confusion of the occupant to be provided with the information is increased due to the automatic control of the vehicle, and changes the information to be provided to the occupant depending on the degree of confusion and the degree of recognition. By doing so, the information providing device 1 can prevent information from being unnecessarily provided for a confusion unrelated to the automatic control, and thereby can prevent the occupant from being annoyed.

Furthermore, in the above description, the information providing device 1 has been described assuming that the target to be provided with information is one occupant, but it is possible to target all the plurality of occupants who are on board the vehicle. In that case, for example, the information providing device 1 selects, on the basis of the degree of confusion and the degree of recognition of each occupant, an occupant who needs the largest amount of information to be provided, generates information depending on the degree of confusion and the degree of recognition of the occupant, and provides the information to all the occupants by using one output device 12 installed in the vehicle. Alternatively, the information providing device 1 may generate information individually depending on the degree of confusion and the degree of recognition of each occupant, and individually provide the information by using the output device 12 installed in each seat.

Furthermore, in the above, an example has been described in which the information providing device 1, the vehicle control device 10, the input device 11, and the output device 12 are mounted on the vehicle; however, it is not limited to this configuration. For example, the information providing device 1 may be configured as a server device outside the vehicle, and the server device may provide information by performing wireless communication with the vehicle control device 10, the input device 11, and the output device 12 that are mounted on the vehicle. Furthermore, the host vehicle status acquiring unit 2, the occupant state acquiring unit 3, the confusion degree determining unit 4, the recognition degree determining unit 5, the information generation unit 6, and the information generation table 7 of the information providing device 1 may be distributed to the server device, a mobile terminal such as a smartphone, and a vehicle-mounted device.

Furthermore, in the above, the case has been described where the information providing device 1 is used for a four-wheeled vehicle, as an example; however, the information providing device 1 may be used for moving objects such as a two-wheeled vehicle, a ship, an aircraft, and a personal mobility which an occupant boards.

Note that, in the present invention, it is possible to modify any of the components of the embodiment or omit any of the components of the embodiment within the scope of the invention.

### INDUSTRIAL APPLICABILITY

Since the information providing device according to the present invention is configured to provide information in consideration of the state of the occupant, it is suitable for use as an information providing device of a vehicle or the like that performs automatic driving or driving assistance.

### REFERENCE SIGNS LIST

1: information providing device, 2: host vehicle status acquiring unit, 3: occupant state acquiring unit, 4: confusion degree determining unit, 5: recognition degree determining unit, 6: information generation unit, 7: information generation table, 10: vehicle control device, 11: input device, 12: output device, 100: bus, 101: CPU, 102: ROM, 103: RAM, 104: HDD

1. An information providing device comprising:
a processor to execute a program; and
a memory to store the program which, when executed by the processor, performs processes of,
acquiring first information indicating surrounding conditions of a vehicle and second information regarding automatic control of the vehicle;
acquiring third information indicating a state of an occupant of the vehicle;
determining a degree of confusion of the occupant by using the third information acquired by the occupant state acquiring unit;
determining a degree of recognition of the occupant, with respect to the surrounding conditions and the automatic control of the vehicle, by using the first information, the second information, and the third information acquired; and
generating information to be provided to the occupant by using the first information and the second information acquired, the degree of confusion determined, and the degree of recognition determined.

2. The information providing device according to claim 1, wherein the processes further include increasing or decreasing an amount of the information to be provided to the occupant depending on the degree of confusion determined or the degree of recognition determined.

3. The information providing device according to claim 2, wherein the processes further include increasing the amount of the information to be provided to the occupant as the degree of confusion determined is higher, or as the degree of recognition determined is lower.

4. The information providing device according to claim 1, wherein the processes further include determining the degree of confusion of the occupant by using the third information which indicates at least one of the occupant's facial expression, line of sight, behavior, voice, heart rate, sweat rate, or number of rides, and which is acquired.

5. The information providing device according to claim 1, wherein the processes further include estimating a current degree of confusion by using a history of past determination of a degree of confusion performed for the occupant.

6. The information providing device according to claim 1, wherein the processes further include
determining a matter recognized by the occupant, in the surrounding conditions and the automatic control of the vehicle, and
generating information regarding the surrounding conditions and the automatic control of the vehicle which are other than the matter determined to be recognized by the occupant.

7. The information providing device according to claim 1, wherein the processes further include generating the information to be provided to the occupant by using the first information and the second information acquired, the degree of confusion determined, and the degree of recognition determined, and providing the generated information to the occupant, and then, when a degree of confusion newly determined does not decrease by greater than or equal to a predetermined value, increasing an amount of information to be provided to the occupant.

8. The information providing device according to claim 1, wherein the information to be provided to the occupant does not change when the degree of confusion of the occupant is increased due to a conversation with another occupant.

9. An information providing method comprising:
acquiring first information indicating surrounding conditions of a vehicle and second information regarding automatic control of the vehicle;
acquiring third information indicating a state of an occupant of the vehicle;
determining a degree of confusion of the occupant by using the third information acquired;
determining a degree of recognition of the occupant, with respect to the surrounding conditions and the automatic control of the vehicle, by using the first information, the second information, and the third information acquired; and
generating information to be provided to the occupant by using the first information and the second information acquired, the degree of confusion determined, and the degree of recognition determined.
